(19) United States
(12) Patent Application Publication
(10) Pub. No.: US 2009/0017169 A1
(43) Pub. Date: Jan. 15, 2009

(54) METHOD FOR MAKING HARD PRETZELS THAT EFFECTIVELY ABSORB SEASONING SLURRY

(76) Inventors: Kimberly Nicole ASSAAD, Dallas, TX (US); Donald Casimir Bernard, Frisco, TX (US); Larry Nelson Elliott, Bel Air, MD (US); Michael Allen Oates, Lucas, TX (US)

Correspondence Address: CARSTENS & CAHOON, LLP, P O BOX 802334, DALLAS, TX, 75380, US

(21) Appl. No.: 11/776,271

(22) Filed: Jul. 11, 2007

(51) Int. Cl. A21D 8/02; A23P 1/08; A23P 1/12; A21D 13/00

(52) U.S. Cl. 426/89; 426/302; 426/303

(57) ABSTRACT

A method for making a hard pretzel product that effectively absorbs a seasoning slurry, such as an oil-based seasoning added after baking. In a preferred embodiment, three dough strands extruded simultaneously are cut and formed into a triad arrangement of three dough rods. Several process steps are used singly or in combination to promote the formation of a stress cracking at the intersection between these three rods in the triad formation. During the final drying stage and a seasoning stage in a seasoning tumbler, this stress cracking is sufficient to allow separation of the three rods into individual pretzel sticks. Each of these pretzel sticks has a longitudinal surface area in the proximity of the original stress fracturing which effectively absorbs a seasoning slurry.

### BACKGROUND OF THE INVENTION

1. Technical Field

The present invention relates to a method for making hard pretzel sticks and, in particular, to a method for making a pretzel product that effectively absorbs a seasoning slurry, such as an oil-based seasoning added after baking. The invention uses several processing levers in order to produce a hard pretzel stick that has an available surface for the absorption of a seasoning added after baking.

2. Description of Related Art

Hard pretzels are typically extruded, flour-based baked products that have gone through a caustic bath prior to cooking and dehydration. Unlike soft pretzels, hard pretzels have a final moisture level low enough to make them good candidates for packaging as a snack food having a relatively long shelf life. Hard pretzels are quite popular as a snack food, particularly in the United States, and come in a variety of sizes and shapes, including a small version of the traditional soft pretzel shape, a twisted shape involving two or more extruded dough strands that are twisted or braided prior to cutting individual pieces, and pretzel stick or rod shapes.

As with soft pretzels, hard pretzels have a dark brown and glossy exterior finish resulting from the caustic bath step that occurs prior to baking. This hard glossy finish is a low porosity exterior shell that makes it difficult to apply seasoning to hard pretzels by traditional snack food means, such as using a seasoning tumbler with a seasoning slurry. Put simply, the seasoning thus applied tends to fall off, which reduces consumer appeal and leads to a number of production problems such as seasoning build-up on the equipment used during and post seasoning. It is possible to get some seasoning adherence when using a water-based spray that is applied to cooked pretzels. However, water-based seasoning media does not deliver the same robust flavor characteristics as an oil-based seasoning media. Consequently, it is quite difficult to impart many of the interesting and intense flavors onto hard pretzels using seasoning techniques that are routinely used with other snack foods, such as potato chips and corn chips. Yet, marketing studies have shown that a highly seasoned, hard pretzel is desirable for many consumers.

One prior art approach to this problem is to physically break hard pretzels into irregular pieces, thereby exposing surfaces that are not covered with the hard glossy shell. These exposed surfaces are much more capable of effectively absorbing a seasoning, such as an oil-based seasoning. As a result, these pretzel pieces can be seasoned with a number of interesting and flavorful seasonings that cannot be used practically with unbroken hard pretzels. It would be desirable, however, to devise a method to season hard pretzels so that the pretzels do not have the appearance of being broken into irregular pieces.

A need exists, therefore, for a method of producing hard pretzels that are well-suited for the effective absorption of seasoning, including an oil-based seasoning slurry. This method should produce pretzels that are recognizable as being complete pretzel products, without the appearance of being broken into smaller and irregular components or pieces. Ideally, such method should use, as much as possible, standard pretzel processing techniques and machinery. The end product should also maintain some of the hard pretzel bite and flavor characteristics as well as have a good shelf life.

### SUMMARY OF THE INVENTION

The proposed invention comprises a method for making a hard pretzel having a portion of its surface available for the absorption of a seasoning slurry. In a preferred embodiment, this involves simultaneously extruding three pretzel dough strands in a triad arrangement with one dough strand on top and two dough strands on the bottom. These dough strands are cut into individual pieces, still maintaining the triad arrangement of three sticks or strands grouped together. A dough having a lower than normal moisture level is used in order to reduce the adherence as between the three sticks. A lower caustic concentration is used in the caustic bath so that the hard shell formed around the triad of sticks is less hard than had the shell been formed by prior art production processes. When cooked in an oven after the caustic bath, the humidity level in the oven is manipulated such that the first portion of the cooking process is in an extremely low humidity (dry) environment, which is contrary to the prior art. The final moisture level of the product is also slightly lower than prior art hard pretzels. This lower final moisture level is achieved by additional drying in a kiln step.

The result of the above processes imparts stress fractures between the contact areas of the three strands or sticks that comprise the triad previously described. These stress fractures allow for the three individual sticks to break apart, some in the kiln and the rest in a later seasoning tumbler, thereby exposing the former contact area of each of the three sticks. Thus, the parting of the sticks from the triad exposes the more highly absorptive pretzel internal area along a portion of each stick. Upon parting, the three strands are now individual pretzel sticks, each having a portion of its surface area available for effective absorption of a seasoning slurry.

The end result is a hard pretzel that appears as a normally-formed and unbroken rod or stick shape. However, this pretzel piece formed by Applicants' invention is not completely encased in the hard glossy shell, but, rather, there is a strip running longitudinally down each stick that is in essence exposed and available for absorbing a seasoning slurry. This exposed strip provides just enough surface area for a hard pretzel made by Applicants' invention to absorb oil-based seasoning, thereby providing opportunities to make new and interesting seasoned pretzels. Further, Applicants' invention uses standard pretzel manufacturing equipment and is easily adaptable to existing pretzel lines. The end product is familiar in appearance, maintains much of a hard pretzel's bite and flavor characteristics, and is shelf stable.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, farther objectives and advantages thereof will be best understood by reference to the following detailed description of illustrative embodiments when read in conjunction with the accompanying drawings, wherein:

FIG. 1 is a flowchart illustrating both Applicants' invention and prior art hard pretzel processes;

FIGS. 2a, 2b, 2c, 2d, and 2e are schematic representations of various embodiments of an extrusion hole followed by the rod dough shape produced by such hole after extrusion and cutting in accordance with Applicants' invention;

FIGS. 3a, 3b, 3e, and 3d are schematic plan views of various extruder hole shapes reflecting various embodiments of Applicants' invention;

FIGS. 4a and 4b are schematic plan views of additional extruder hole shapes relating to various embodiments of Applicants' invention;

FIG. 5a is a perspective view in elevation of a pretzel dough strand triad exhibiting stress cracks prior to breakage between the individual sticks in accordance with a preferred embodiment of Applicants' invention; and

FIG. 5b is a perspective view in elevation of a single pretzel stick of Applicants' invention.

### DETAILED DESCRIPTION OF THE PREFERRED EMBODIMENTS

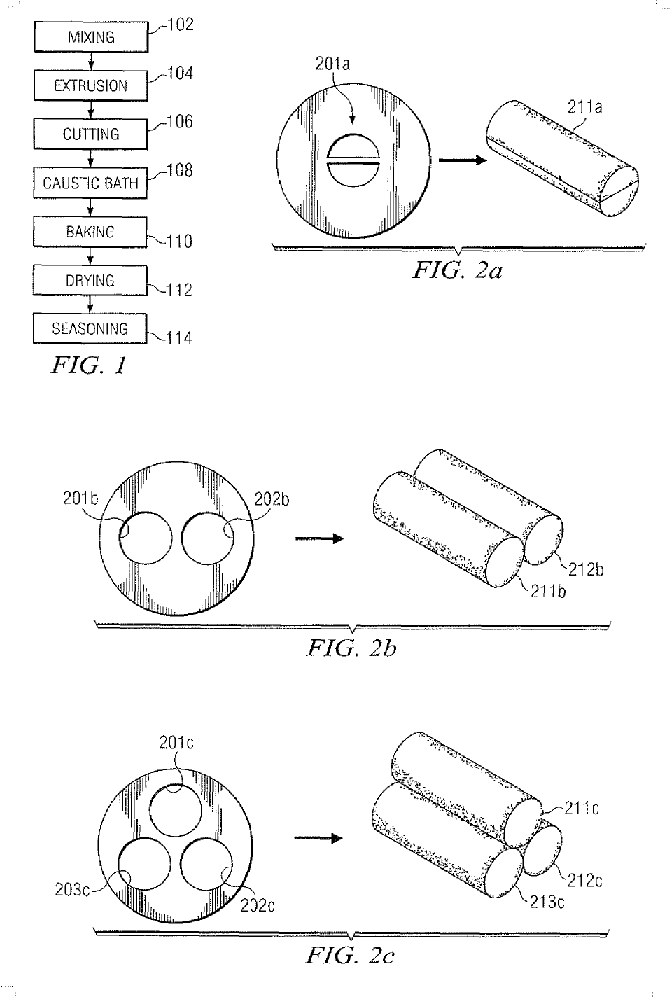

Applicants' invention is best understood in contrast with prior art methods for making hard pretzel product, such as pretzel rods/sticks or pretzel twists. Referring to FIG. 1, the first step in the process of making a hard pretzel is to mix 102 the starting ingredients, which primarily comprises wheat flour. Other constituents can include corn syrup, corn oil, sodium bicarbonate, ammonium bicarbonate, malt syrup, and yeast. These ingredients are typically mixed 102 in a low-sheer mixer with water to a moisture level of between 38% and 45% by weight. The mixing 102 takes place at ambient pressures and typically between 80° F. to 100° F. After the mixing step 102, the dough is fed into an extruder for an extrusion step 104. This extrusion 104 is again characterized as low sheer and is done at ambient temperatures and typically rather low pressures, for example less than 100 psig. The dwell time in the extruder during the extrusion step 104 varies, but is typically in the 10 to 15 minute range.

The dough exits the extruder after the extrusion step 104 in, for example, a single dough strand or rope configuration. This dough strand must be cut during a cutting step 106 to individual strand segments. Once the segments are formed by the cutting step 106, these dough strands are conveyed to a caustic bath for a caustic bath step 108. The caustic bath, using prior art methods, typically is about a 1% to 2% caustic aqueous solution between 180° F. to 200° F. The dwell time during the caustic bath step 108, depending on the product being made, can range from less than 10 seconds to up to about 25 seconds.

From the caustic bath step 108, the dough strands are then conveyed to an oven for a baking step 110. It is the goal in the prior art for this oven to form the hard shell around the pretzel pieces as slowly as possible in order to avoid blow-out of the shell by the escaping moisture from within the pretzel piece. As a consequence, the prior art teaches that the humidity level at the beginning of the baking step 110 should be maintained relatively high, thus avoiding the rapid formation of the hard shell. In order to accomplish this, the prior art typically uses an oven during the baking step 110 that has three separate zones. The temperature in each zone is usually either approximately the same, such as about 550° F., or decreases as the piece proceeds through each zone. The humidity level in each zone goes from a high humidity level to a relatively low humidity level as the piece proceeds from zone one through zone three. To quantify this, it should be understood that the vast majority of ovens presently used in the hard pretzel industry are manufactured by Reading Bakery Systems of Robesonia, Pa. These ovens consist of at least two and typically three cooking zones and maintain a humidity level in each zone by adjusting a vent or exhaust setting on each zone by a certain percent, 0% being as closed as possible and 100% being as open as possible. The prior art teaches, and the manufacturer instructs, that the first zone should have a vent opening of about 10%-30%, the second zone having a vent opening of about 40-60%, and the third zone having a vent opening of 70%-100%. As a consequence, the humidity in the first zone is very high and the humidity in the third zone is very low. This arrangement allows for the slow formation of the hard shell on the pretzel without explosive disruption of the shell during the baking step 110. The total dwell time during the baking step 110 is typically between about 3 to about 10 minutes at a temperature of between 450° F. and 600° F. The product exits the baking step 110 at a moisture level of typically between 8 and 15%.

The prior art product next proceeds to a drying step 112 which typically takes place in a drying kiln. Dwell time in this kiln during the drying step 112 is typically between 10 and 60 minutes at a temperature of something less than 350° F. in accordance with the prior art. The pretzel product emerges from the drying step 112 at a moisture level typically of between 2% to 6%. The pretzel product can then be packaged once it exits the kiln at the drying step 112, but can alternatively be further seasoned at a seasoning step 114. In the prior art, the seasoning steps are limited to the application of water-based seasoning as previously discussed.

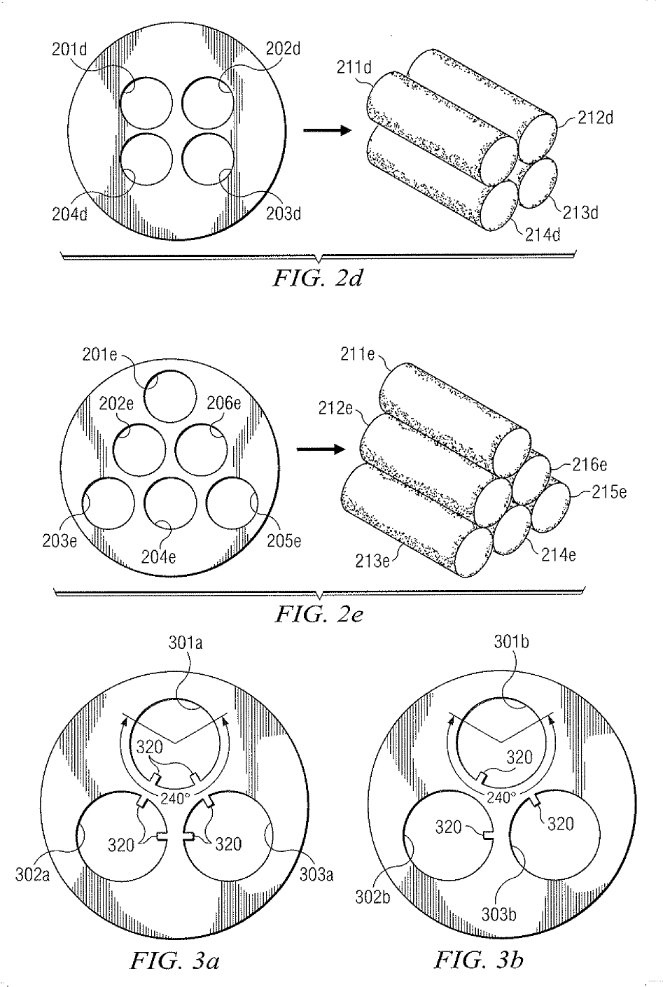

One of the goals of Applicants' invention is to provide a surface area along the length of each pretzel stick that can effectively absorb seasoning slurry. Stated another way, Applicants' invention produces pretzel sticks having a portion of the surface area that is not covered by the hard shell. The preferred method for doing this involves the proximal extrusion of three dough strands into a triad arrangement, such as is show in FIG. 2c, which illustrates a preferred extrusion die. Shown in a plan view are three extrusion holes or nozzles 201c, 202c, 203c, arranged proximally in a triad or triangular orientation with one hole 201c located above two other holes 202c, 203c on the die, which is the preferred orientation of the three holes 201c, 202c, 203c. When dough is extruded through these three holes 201c, 202c, 203c, the dough rope or strand on top 211c falls onto and contacts the two lower dough ropes 212c, 213c. When the dough ropes are cut during the cutting step 106 of FIG. 1, the three strands 211c, 212c, 213c form a single triad-shaped piece. As an aside, this extrusion through three holes 201c, 202c, 203c is used in the prior art to produce a braided pretzel piece, except that in the prior art the three holes 201c, 202c, 203c are rotated during the extrusion process in order to twist the dough strands together. Applicants' invention maintains these three extrusion holes 201c, 202c, 203c in a stationary position such that the dough strands are linear, because the additional adhesion imparted between the three dough strands by the twisting motion is undesirable for Applicants' purposes. The holes 201c, 202c, 203c are also said to be “proximal,” which Applicants intend to mean that they are located close enough together that the strands stick together when exiting the co-located holes 201c, 202c, 203c.

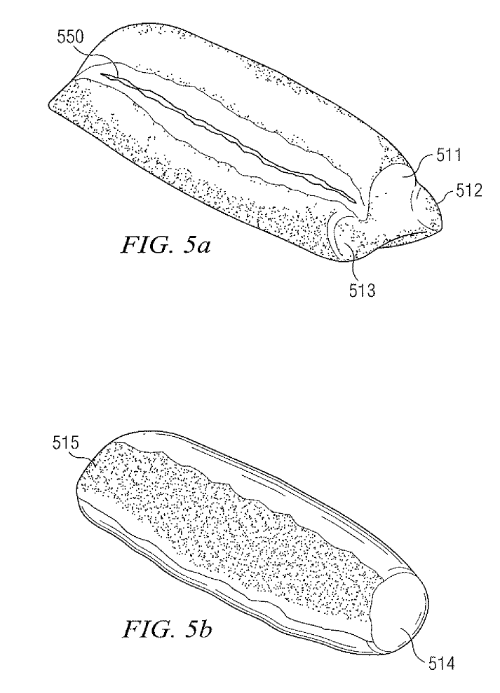

In this preferred embodiment, Applicants' process promotes the formation of stress fractures between the boundaries of the three sticks. Skipping forward for a moment, these stress fractures are illustrated in FIG. 5a, which shows the preferred triad arrangement embodiment of three sticks 511, 512, 513 as this triad arrangement emerges from the baking step 110 or drying step 112 of FIG. 1. As can be seen in FIG. 5a, a stress fracture 550 has formed between the top stick 511 and one of the bottom stick 513. A similar stress fracture is formed on the opposite side of the piece (not shown) as between the top stick 511 and the other bottom stick 512. A stress fracture between the two bottom sticks 512, 513 is also formed (not shown).

Because of the formation of these stress fractures 550, very little mechanical stress is required to break the three-strand elements 511, 512, 513 into their individual component pieces or sticks. Such an individual stick is illustrated in FIG. 5b. Shown is an individual stick 514 and the exposed surface area 515 that used to be the intersection or contact area between this stick 514 and the other two in the triad arrangement of FIG. 5a. It is this exposed surface area 515 that is absorbent to a seasoning slurry, thus accomplishing the goal of Applicants' invention. In a preferred embodiment, this exposed area 515 is usually on the order of approximately 20% to 30% percentage of the circumferential surface area of the individual stick 514. The remaining surface area of the individual stick 514 comprises the hard shell that is characteristic of a hard pretzel.

In order to develop the stress fracturing discussed above, Applicants utilize several changes to the prior art process for making hard pretzels. What follows is a description of various process levers which may be used individually or in combination as a part of Applicants' invention in order to achieve the goals stated herein.

Referring again to FIG. 1, one of the levers used by Applicants is to decrease the moisture level at the mixing step 102 in order to minimize the stickiness of the individual dough ropes, thus limiting their adhesion to each other. This goal is contrary to the prior art which, when extruding multiple dough ropes in a co-location arrangement, finds it desirable that the ropes adhere as much as possible to each other. Running contrary to the prior art, Applicants prefer a dough moisture of preferably between about 30% and about 38% by weight, more preferably between about 33% and about 36% by weight, and most preferably about 34%. In order to achieve this, in a preferred embodiment Applicants use the following ingredients at the mixing step 102.

TABLE 1
Dough Formulation

| Ingredient | Formulation (lbs.) |
|---|---|
| Enriched Wheat Flour | 500.0 |
| Corn Syrup | 15.0 |
| Leavening Slurry | 11.2 |
| (Water, Ammonium | |
| Bicarbonate, Sodium | |
| Bicarbonate) | |
| Corn Oil | 15.0 |
| Water (AIM) | 180.0 |
| TOTAL BATCH WEIGHT | 721.2 |

Again, with reference to FIG. 1, Applicants can use various approaches during the extrusion step 104 to promote breakage as between the individual later-formed pretzel sticks. All of these arrangements involve proximally extruding at least two linear dough strands simultaneously. One of these arrangements has already been discussed with regard to FIG. 2c as Applicants' preferred embodiment. Another embodiment involves slicing what would be an individual strand 211a in half (thus forming two strands) using an extrusion hole 201a with a divider running through the middle of the circular shape, as shown in FIG. 2a. This promotes a stress fracture along this slice line. Another embodiment shown in FIG. 2b uses two co-located extrusion holes 201b, 202b that produce a double-strand arrangement consisting of a first stick 211b and a second stick 212b. Another embodiment is reflected in FIG. 2d, which shows four co-located extrusion holes 201d, 202d, 203d, 204d. This four-hole arrangement produces a four-strand cluster consisting of two top sticks 211d, 212d and two bottom sticks 213d, 214d. Another embodiment is illustrated in FIG. 2e which shows a pyramid arrangement with six extrusion holes 201e, 202e, 203e, 204e, 205e, 206e, that produce a pyramid shape dough piece of six sticks 211e, 212e, 213e, 214e, 215e, 216e. As with Applicants' preferred embodiment shown in FIG. 2c, with all of these alternative embodiments shown in FIGS. 2a, 2b, 2d, and 2e, stress fractures are formed at the intersections or contact areas of the individual strands. These stress fractures as they propagate pop the individual strands apart in order to form individual pretzel sticks.

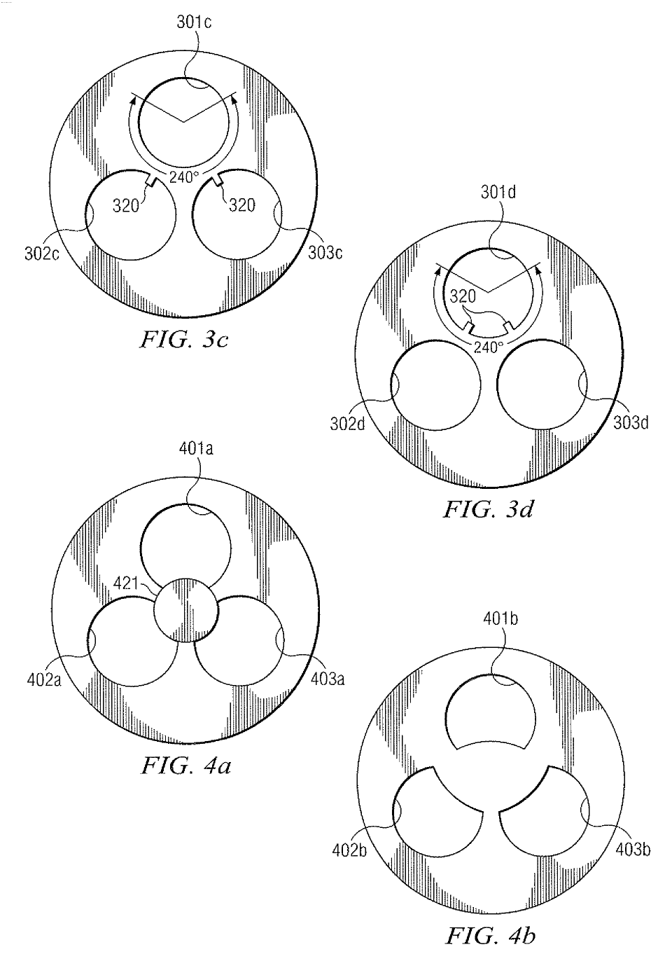

It is also possible to enhance the stress fracturing characteristics in the preferred three-rod arrangement (and others) by various modifications to the extrusion holes. These modifications are illustrated in FIGS. 3a, 3b, 3c, and 3d.

Referring to FIG. 3a, shown as a plan view of three extrusion holes 301a, 302a, 303a. Also shown is a plurality of notches 320 in each of the holes 301a, 302a, 303a. This embodiment of Applicants' invention requires two notches 320 per each hole 301a, 302a, 303a, in any location within a 240° radius. These notches 320 reduce the surface area in contact by the dough strands, thus reducing the adhesion between the dough strands formed thereby.

A similar embodiment is reflected in FIG. 3b. Again shown are nozzle holes 301b, 302b, 303b, and a plurality of notches 320. In this embodiment of Applicants' invention there is one notch 320 per each hole 301b, 302b, 303b, with each notch 320 placed in any location within a 240° radius as shown.

Similar arrangements can be seen in FIGS. 3c and 3d. FIG. 3c shows three holes 301c, 302c, 303c, with one notch 320 each placed in two of the holes 302c, 303c in any location within a 240° radius as shown. In FIG. 3d, two notches 320 are placed on any one hole 301d, 302d, 303d within a 240° radius as shown.

Similar concepts are reflected as alternative embodiments shown in FIG. 4a and 4b. In FIG. 4a, a pin 421 is placed at the intersection of the three holes 401a, 402a, 403a in order to limit the surface area of the thus-formed rods at this intersection. The same concept can be achieved by using holes 401a, 402a, 403a having the shapes shown in FIG. 4a without the pin 421. A similar concept is shown in FIG. 4b involving holes 401b, 402b, 403b that are not quite spherical. Again, the idea is to limit the surface area in contact at the intersection of the dough strands formed by such holes 401b, 402b, 403b.

All of the variations shown in FIGS. 3a-3d and FIGS. 4a and 4b of different extruder die designs strive to reduce the contact area between the formed dough rods or disrupt this contact area, thereby promoting breakage as between the rods later in the process, as will be described below. These specific embodiments are shown by way of example only, as other extrusion hole shapes can be used to promote the same goal.

Regardless of the shape used, Applicants find that, for their preferred embodiment, it is best to cut the dough rope during the cutting step 106 of FIG. 1 into shorter segments than is typically used in the prior art. For example, most prior art rod pretzels are cut into a length of greater than 3.0 inches, or greater than 7.6 centimeters. Applicants' preferred embodiment cuts the dough strands during the cutting step 106 to a length of about 4.7 centimeters. This shorter length limits the contact area between the individual dough strands, thus promoting the formation of the stress fracture between the strands.

Another lever used to promote the formation of the stress fracture between the rods is the reduction in the caustic concentration in the caustic bath 108 of FIG. 1. As previously noted, prior art uses an aqueous caustic bath with a 1% to 2% caustic concentration. Applicants prefer a caustic concentration of between about 0.1% and about 0.5%, or more preferably about 0.3%, for a dwell time of preferably 15 to 25 seconds. This lower caustic concentration gives rise to a shell around the pretzel rods that is less hard than prior art shells, again thereby promoting the formation of the stress fractures as between the strands. To the extent that any pretzel flavor characteristics are lost by using this lower caustic level, this can be compensated for by later seasoning.

Another lever used by Applicants to promote the stress fracturing turns the prior art teaching regarding the baking step 110 on its head. As previously noted, the prior art requires that the baking step involve zones that become progressively less humid, with a first zone that is very humid, followed by an intermediate zone that is somewhat humid, and a final zone which is maintained at a low humidity. Referring again to the vent opening settings previously discussed, Applicants use a vent setting in the first zone of preferably between about 80% to about 100%, or more preferably about 90% open. The second zone in Applicants' baking step 10 is preferably maintained with a vent setting of about 60% to about 90% open, or more preferably about 80% open. Applicants maintain zone three at about 60% to about 90% open, or more preferably about 80% open. This creates a unique low humidity profile in the oven used for Applicants' baking step 110. Applicants also preferably use a temperature that is about 50° F. higher in the first zone than that used in the following two zones, or preferably about 575° F. to 525° F. in the first zone. However, temperature similar to those used in the prior art can also be used with Applicants' process.

Applicants use this unique humidity profile through the baking step 110 in order to form the hard shell as quickly as possible, which is a goal specifically avoided by the prior art. By forming this hard shell quickly during the baking step 110, Applicants promote the formation of the stress crack as between the individual rods. The rapid formation of the hard shell as well as the increased concentration gradient for moisture escaping the strands due to the low humidity environment promotes explosive rupturing at the intersection of the dough strands in Applicants' preferred triad arrangement.

Another lever used by Applicants to promote the stress crack formation is additional drying during the drying step 112. Prior art pretzel manufacturing involves drying the pretzel during the drying step 112 to a moisture level of typically between 2% and 6% by weight. Applicants, however, in a preferred embodiment, dry the pretzel rods to a moisture level of less than 2% by weight, or preferably about 1.8%. This is accomplished by using higher drying temperatures and/or longer dwell times in the drying step than is taught by the prior art. It is at this point, during the drying step 112 that breakage between the individual rods in the preferred triad arrangement begins to take place. It has been observed in product runs that it is not unusual for about one-third of the triad grouping to break apart during the drying step 112 such that at least one of the strands is separated from the group.

The remaining triad groupings are broken apart during the seasoning step 114 by placing the dried pretzel product into a seasoning tumbler, such as a spiral tumbler or other tumblers used in the field of snack food seasoning. The physical stresses imparted on a snack product placed in such seasoning tumblers is relatively gentle. However, due to the processing steps described above, such physical stresses are adequate to further propagate the stress cracks and separate the individual rods or sticks from the triad arrangement of Applicants' preferred embodiment. This separation, as previously described and in reference to FIG. 5b, exposes a longitudinal strip 515 along the surface of the stick 514 that is susceptible to the adherence of an applied seasoning. Even if only one stick is broken loose from the triad grouping, there is still surface area available on the remaining two joined sticks for the adherence of seasoning. While it is preferred that all three strands part company every time, the process still accomplishes the goal of increased seasoning adherence when this does not happen. The end result is the production of pretzel sticks that can be highly seasoned with oil-based and other seasonings.

While the invention has been particularly shown and described with reference to a preferred embodiment, it will be understood by those skilled in the art that various changes in form and detail may be made therein without departing from the spirit and scope of the invention.

What is claimed is:

1. A method for making hard pretzels from a dough, said method comprising the steps of:
a) proximally extruding at least two linear dough strands simultaneously;
b) cutting said at least two dough strands, thereby forming a dough piece comprising at least two dough strands;
c) exposing said dough piece to a caustic bath;
d) baking said dough piece in an oven; and
e) breaking said at least two dough strands apart, thus forming individual pretzel sticks.

2. The method of claim 1 wherein three linear dough strands are proximally extruded at step a).

3. The method of claim 1 wherein said formed dough piece of step b) is about 4.7 centimeters in length.

4. The method of claim 1 wherein the caustic bath of step c) comprises a caustic concentration of between about 0.1% and about 0.5%.

5. The method of claim 4 wherein said caustic bath consists of a caustic concentration of about 0.3%.

6. The method of claim 1 wherein said baking of step d) occurs in at least two zones.

7. The method of claim 6 wherein a low humidity is maintained in the first zone.

8. The method of claim 6 wherein the humidity in each zone is controlled by adjusting a vent setting specific to each zone, wherein each vent has an adjustable setting of between 0% and 100%, with 0% being as closed as possible and 100% being as open as possible.

9. The method of claim 8 wherein the vent setting in a first zone is between about 80% to about 100%.

10. The method of claim 8 wherein the vent setting in a second zone is between about 60% to about 90%.

11. The method of claim 1 wherein the dough piece is dried after the baking step d) to a moisture level of less than about 2% by weight.

12. The method of claim 11 wherein the dough piece is dried to a moisture level of about 1.8% by weight.

13. The method of claim 1 wherein said dough prior to the extruding step a) comprises a moisture level by weight of between about 30% and about 38%.

14. The method of claim 13 wherein said dough moisture is between about 33% and about 36% by weight.

15. The pretzel made by the method of claim 1.

16. A method for making a hard pretzel, said method comprising the steps of:
a) mixing a dough comprising between about 30% and about 38% moisture by weight;
b) proximally extruding at least two linear dough strands simultaneously;
c) cutting said at least two dough strands, thereby forming a dough piece comprising at least two dough strands;
d) exposing said dough piece to a caustic bath;
e) baking said dough piece in low humidity; and
f) breaking said at least two dough strands apart, thus forming individual pretzel sticks.

17. The method of claim 16 wherein three linear dough strands are proximally extruded at step b).

18. The method of claim 16 wherein said formed dough piece of step c) is about 4.7 centimeters in length.

19. The method of claim 16 wherein the caustic bath of step d) comprises a caustic concentration of between about 0.1% and about 0.5%.

20. The method of claim 19 wherein said caustic bath consists of a caustic concentration of about 0.3%.

21. The method of claim 16 wherein said baking of step e) occurs in at least two zones.

22. The method of claim 21 wherein a low humidity is maintained in the first zone.

23. The method of claim 21 wherein the humidity in each zone is controlled by adjusting a vent setting specific to each zone, wherein each vent has an adjustable setting of between 0% and 100%, with 0% being as closed as possible and 100% being as open as possible.

24. The method of claim 23 wherein the vent setting in a first zone is between about 80% to about 100%.

25. The method of claim 23 wherein the vent setting in a second zone is between about 60% to about 90%.

26. The method of claim 16 wherein the dough piece is dried after the baking step e) to a moisture level of less than about 2% by weight.

27. The method of claim 26 wherein the dough piece is dried to a moisture level of about 1.8% by weight.

28. The method of claim 16 wherein said dough moisture at step a) is between about 33% and about 36% by weight.

29. The method of claim 16 further comprising the steps of:
g) seasoning said pretzel sticks with a seasoning slurry.

30. The method of claim 29 wherein said seasoning slurry comprises an oil-based seasoning.

31. The pretzel made by the method of claim 16.
